(19) United States
(12) Patent Application Publication
(10) Pub. No.: US 2007/0214232 A1
(43) Pub. Date: Sep. 13, 2007

(54) System for Uniform Addressing of Home Resources Regardless of Remote Clients Network Location

(75) Inventors: Petros Belimpasakis, Tampere (FI); Harri Hakulinen, Pirkkala (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/276,595

(22) Filed: Mar. 7, 2006

(51) Int. Cl. G06F 15/16

(52) U.S. Cl. 709/217

(57) ABSTRACT

A method and apparatus is provided for enabling devices to access and control each other though located on different and remote networks. A gateway resolves device name problems such that same device names are resolved to different IP addresses depending if the DNS lookup request originates from the internal network or external network.

### FIELD OF THE INVENTION

The invention relates generally to accessing devices from a remote location. More particularly, the present invention relates to accessing home resources located on a home network through a HTTP proxy gateway from a remote network.

### BACKGROUND OF THE INVENTION

Currently, user devices connected to various home networks that use Internet Protocol (IP) connectivity may be accessed and/or controlled from a personal computer or other smart device. The home devices that may be accessed or controlled include devices such as personal computers, personal video recorders (PVRs), and other media type devices. In addition, the number of these “smart” devices used in a home environment is expected to significantly increase in the near future.

In most cases, Internet Service Providers (ISPs) assign a dynamic public IP address to each of their customers. Typically IP addresses are assigned within home networks through use of a Dynamic Host Configuration Protocol (DHCP) server. A Dynamic Host Configuration Protocol is a protocol for assigning dynamic IP addresses to devices on a network. With the use of dynamic addressing, a device may have a different IP address every time it connects to the network, (usually after device reboot), or after some time out set by a network operator.

In addition in some systems, a device's IP address may change while the device is still connected. The IP address represents an identifier for a computer or device on a TCP/IP network. Networks using a TCP/IP protocol route messages based on the IP address of the final destination. The format of an IP address is a 32-bit numeric address written as four numbers separated by periods. Within an isolated network, one may assign IP addresses at random as long as each IP address is unique. However, connecting a private network to a public network such as the Internet requires using registered IP addresses to avoid duplication of addresses. Thus, devices on a home network that are to be connected or accessed through an outside network need to be addressable by devices connected to the outside network.

FIG. 1 illustrates a typical network architecture in which an external network 106 such as the Internet is connected to a home network 104 by a gateway 102. The outside network 106 may contain various devices such as a smart device 108, a computer 118, and a server 120 which may provide for a dynamic name service. Those skilled in the art will realize that numerous other devices may be used in connection with external network 106. Similarly, numerous personal devices may be connected to home network 104 such as a PVR 112, a home computer 114, a tablet PC 116, and VoIP phone 117.

FIG. 2 illustrates a common home network 104 that is connected to the Internet 107 through gateway 102. Gateway 102 may connect to an ISP via Ethernet, ADSL, HomePNA, and in most cases uses a NAT (Network Address Translation) technique for providing connectivity to connected home devices. Using this scenario, devices such as home devices 112, 114, 116, and 117 each obtain private IP addresses which may be in the form 192.168.x.y, for example. These IP addresses are not routable from public Internet 107 as only gateway 102 has a public (most often dynamic) IP address. Such a dynamic IP address may take the form of an IP address such as 100.100.100.100 (202). Thus, a user may not connect remotely using a smart device to one of the in-house devices for controlling or accessing the device or its stored contents.

Currently there are a few existing solutions for resolving the above problem, however, each of the solutions suffers from various shortcomings and drawbacks. We discuss each of these existing solutions and their drawbacks below noting that none of the currently existing solutions may be regarded as a successful solution.

A first prior art solution involves the use of a Virtual Private Network (VPN). The VPN provides a method for accessing a home network from a trusted personal device such as a personal mobile phone. However, a VPN solution has numerous drawbacks including the requirement that a VPN client be installed on a remote terminal. Therefore, such a solution may work on smart devices but will not work on simple devices. In addition, a VPN solution may not work using certain corporate resources as many corporate entities do not allow modifications of a client's VPN policies. Moreover, guests or visitors can not be invited to access home devices as a guest or user would be able to obtain the IP access to the whole home network creating a possible security concern. Finally, with a VPN solution the configuration needed is significant and time consuming.

A second prior art solution involves the use of third party services. These third party services create tunnels from home devices to external proxies. However, these third party solutions suffer from major drawbacks as all traffic is routed through the servers of these third party companies. Users of these third party services must ask themselves questions such as: “Why should I trust my personal content going through some non-trusted company?” or “Does this third party company have enough bandwidth for all of their users?” Most third party services only provide a small bandwidth per user, so the fast home connection is not fully utilized. In addition, third party services involve payment of costly monthly subscription fees for use of their services.

A third prior art solution involves use of port forwarding techniques. A port forwarding solution allows a gateway to forward external connections to internal devices. For example, rules may be implemented in which connections from the external network such as the Internet, on port 80 of the external IP address, are forwarded to port 80 of a personal computer located on an internal network. Similarly, connections on a port such as a port 81 of the external IP address may be forwarded to port 80 of a PVR device located on a home network.

However, current port forwarding solutions suffer from numerous problems that include making difficult configurations on the gateway. In addition, typical owners of home networks do not have extensive knowledge regarding IP addresses and ports which would lead to owners creating unknown holes in firewalls of their networks. These holes may expose home devices to external attacks.

Moreover, internal IP addresses of devices might change, in case DHCP is used in a home network (which is the most common configuration). Thus, in case of a reboot, of the gateway/DHCP server for example, all of the connected home devices will get different internal IP addresses. Thus, the static port forwarding settings would need to be reconfigured. Furthermore, home devices have different URLs depending if accessed from an inside network or an outside network. For example, an internal network device address such as a PVR device address may be 192.168.100:80 and if accessed from an external network such as the Internet the PVR device has an address 100.100.100.100:81 (assuming that the 100.100.100.100 is the public address of the gateway, and port 81 is forwarded to port 80). This would confuse users and cause them to have duplicate bookmarks on their portable device (example mobile phones), depending if they access the home devices from the home network or an external network. Finally, problems with some well known ports may lead to potential problems. For example, some phone browsers allow SSL connections only on port 443. If a user has two home devices with SSL, one has to be mapped on a different port (on the gateway), thus the phone would refuse to connect.

A fourth prior art solution involves use of a HTTP Proxy. Such a solution may be useful as HTTP protocols are used extensively. Using a free dynamic DNS service (example www.dyndns.org) one may constantly resolve an IP address from a DNS name. For illustrative purposes in this application and as shown in FIG. 2, we assume that 100.100.100.100 (a public IP address) is mapped to the name “myhome.dns.com” (280). In the HTTP proxy solution, a gateway 102 accepts an HTTP connection on external_address:80 (example myhome.dns.com:80). A special URL pattern may be used for accessing other internal devices. For example, if an external connection is made to gateway 102 and the requested URL is: http://myhome.dns.com/something/192.168.1.100/path, the gateway 102 will connect (internally) to the address 192.168.1.100 and will request URL http://192.168.1.100/path while returning all the results to the original (external) requestor. Therefore, the gateway 102 is acting as an HTTP proxy.

However, current HTTP proxy solutions suffer from numerous problems such as address changing during reboot. For example, FIG. 2 illustrates a URL of remotely accessed device such as PVR 112 may be something like http://myhome.dns.com/something/192.168.1.100/path (206). If the address of PVR 112 changes (e.g. due to reboot), then the external link is also modified. This would cause usability problems for the user as bookmarks on a users device would need to be updated.

Another problem that exists with the current HTTP proxy solutions involves the use of two different bookmarks to obtain access to a particular device depending on whether a device is accessed from an internal network or an external network. For example, a WLAN enabled mobile phone could access a device such as PVR 112 (when within home network), at address http://192.168.1.100/ and this is the bookmark that the user would save on the phone's browser. However, the very same device, when outside a home network, would access the same device using a different address such as http://myhome.dns.com/something/192.168.1.100/. Therefore, a user needs to save a second bookmark on the phone depending upon internal and external access.

Another problem encountered using a HTTP Proxy solution involves the fact that some protocols (example ATOM), require URLs that are absolute. For example, a PVR may have an ATOM feed that exports recordings to the client devices. Within the ATOM xml file of the PVR, there will be a URL like http://192.168.1.100/abc. The gateway should replace it with the external URL. However, current implementations do this only for text/html files. Therefore, new rewrite modules are needed for all protocols.

Finally, another problem encountered using a HTTP Proxy solution involves address translation (html rewrites) that are done in all HTTP protocols. As the process has to scan huge amounts of data, the process is very slow and the translations may not be sufficiently accurate.

Thus, a need exists in the art for a method and apparatus that enables uniform addressing of home resources regardless of device location which overcomes the above shortcoming and limitations of current solutions.

### SUMMARY OF THE INVENTION

In order to overcome the above-described problems and other problems that will become apparent when reading this specification, the present invention provides methods and apparatus for enabling HTTP based applications to work remotely with each other without the limitations of the prior art solutions. In an aspect of the invention, the usage of the dynamic Domain Name Service (DNS) is extended to both outside and inside a home network. Each home device has a fall host name under the home domain. Same device names are resolved to different IP addresses depending if the DNS lookup request originates from the internal network or external network.

In another aspect of the invention, if the lookup request is accomplished from a device that is within the home network, the reply includes the internal IP address of the device.

Once the address is resolved, a user may directly connect to the device. However, if the lookup request is done from an external device (for example mobile phone, or office PC), the DNS reply should contain the public IP address of the home gateway. In this case, the remote client opens a connection to the gateway device. The gateway now accepts an HTTP connection from a remote device. The remote device makes an HTTP request, and in the HTTP header the field “Host” contains the domain name that the user actually wants to contact. Thus, the gateway may differentiate the requests and forward the requests where (which device) they are targeted.

Other features and advantages of the invention will become apparent with reference to the following detailed description and figures.

### BRIEF DESCRIPTION OF THE DRAWINGS

The invention will be described in detail in the following description with reference to the following figures wherein:

FIG. 1 illustrates a prior art home network architecture in accordance with an aspect of the invention;

FIG. 2 illustrates a prior art solution based on use of a HTTP proxy in accordance with an aspect of the invention;

FIG. 3 illustrates a smart device connected to an internal or external network that may be used to access or control other devices found on either network in accordance with an aspect of the invention;

FIG. 4 illustrates various aspects of the invention in which a home network utilizes a gateway (102) which acts as a NAT box, a DNS Server, a DHCP Server, a HTTP Proxy and provides UPnP functionality in accordance with various aspects of the invention;

FIGS. 5-16 illustrate methods of addressing home resources in a uniform fashion through use of gateway from both internal and external locations in accordance with an aspect of the invention;

FIGS. 17-21 illustrates a method of the invention in which a dynamic DNS mechanism is used as a rendezvous mechanism for signaling real time applications in accordance with an aspect of the invention; and

FIG. 22 illustrates a method of the invention in which a dynamic DNS mechanism is used for devices that are located behind firewalls in accordance with an aspect of the invention.

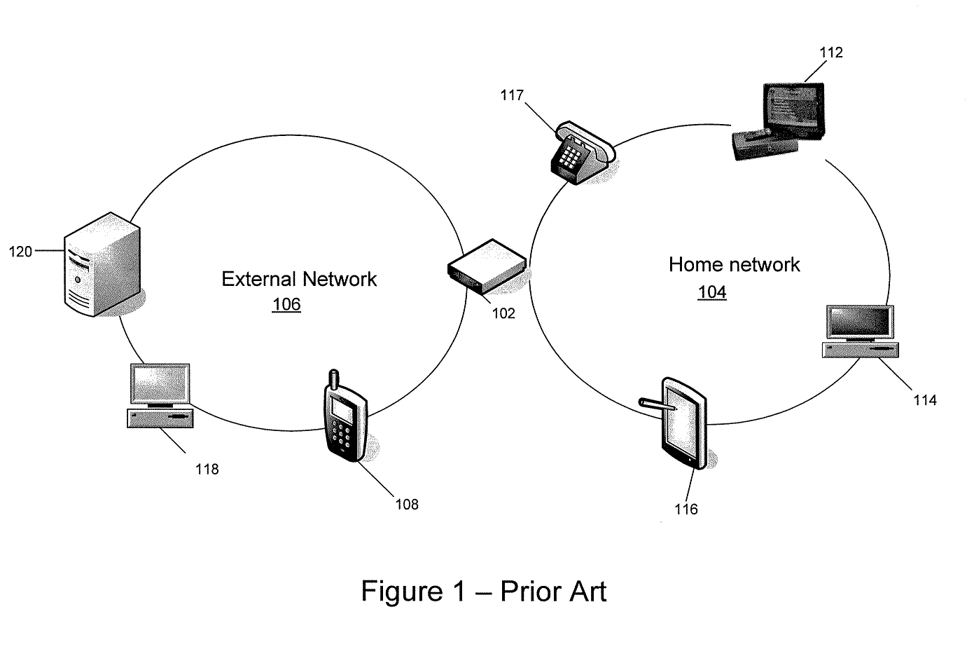

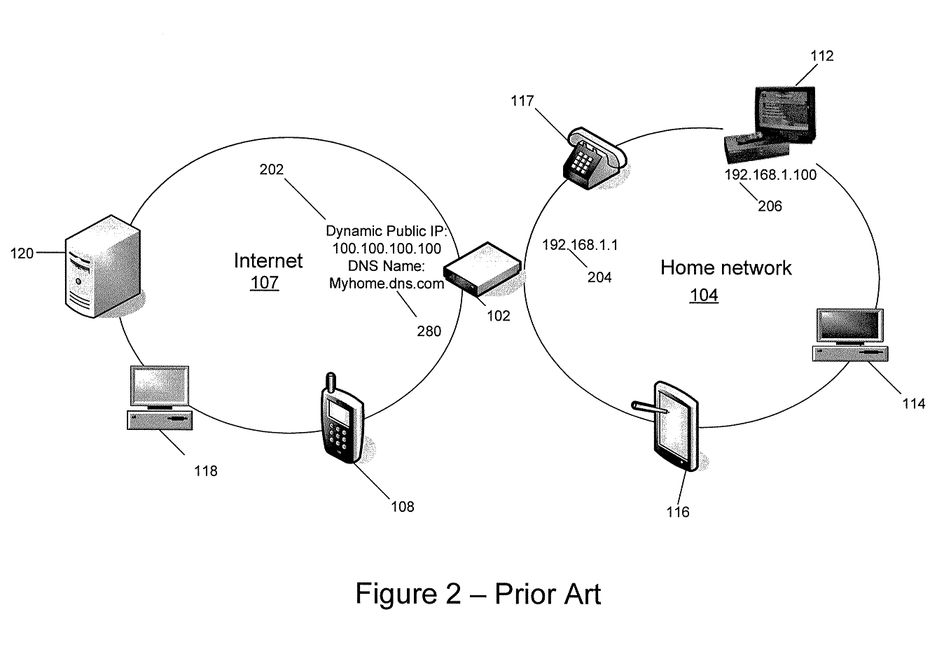

### DETAILED DESCRIPTION OF THE INVENTION

In the following description of the various embodiments, reference is made to the accompanying drawings that form a part hereof, and in which is shown by way of illustration various embodiments in which the invention may be practiced. It is to be understood that other embodiments may be utilized and structural and functional modifications may be made without departing from the scope of the invention.

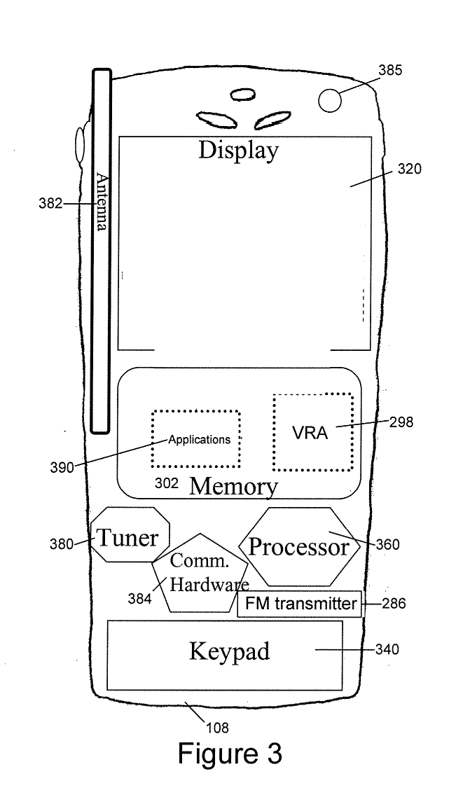

FIG. 3 illustrates a device such as a smart device 108 which may be connected to an external network and used to access or control devices found on an internal or home network. The smart device 108 may be a mobile network-enabled device, such as a personal digital assistant (PDA), cellular telephone, mobile terminal, personal computer, digital or combinations thereof. As shown in FIG. 3, the smart device 108 generally includes any mobile device capable of receiving media and interacting with a digital communication network. As shown in FIG. 3, the smart device 108 may include a display screen 320, memory 302, a keypad 340, a processor 360, a radio tuner 380, a television tuner (not shown), an antenna 382, communication hardware 384, and a camera 385. As is known in the art, the processor 360 performs steps according to instructions stored in the memory 302 and generally interacts with other components of the smart device 108. The display screen 320 displays images and the keypad 340 is adapted to receive inputs from an operator.

The memory 302 may be implemented with any combination of read only memory modules or random access memory modules, optionally including both volatile and nonvolatile memory. Software 390 may be stored within memory 302 and/or storage to provide instructions to processor 360 for enabling smart device 108 to perform various functions. Alternatively, some or all of smart device 108 computer executable instructions may be embodied in hardware or firmware (not shown).

Further, smart device 108 of present invention is not limited to any particular embodiment for enabling data connectivity or broadcast reception. For example, the smart device 108 may use a circuit switched connection for data connectivity, such as a second-generation wireless system using TDMA (Time Division Multiple Access), CDMA (Code Division Multiple Access), GSM (Global System for Mobile Communications), UMTS/3G, WCDMA or other such access systems. In other examples, the smart device 108 may use a packet based access system, such as GPRS (General Packet Radio Service) over a GSM network, or short range connectivity systems such as WLANs (Wireless local area networks) or BLUETOOTH. With regard to possible broadcast tuning, smart device 108 may receive, for example, analog radio transmissions, digital radio transmissions, such as DAB (Digital Audio Broadcasting), DRM (Digital Radio Modiale), satellite radio transmissions, analog television transmissions, digital television transmissions, such as DMB (Digital Multimedia Broadcasting), DVB-H, and DVB-T, or other such broadcasts.

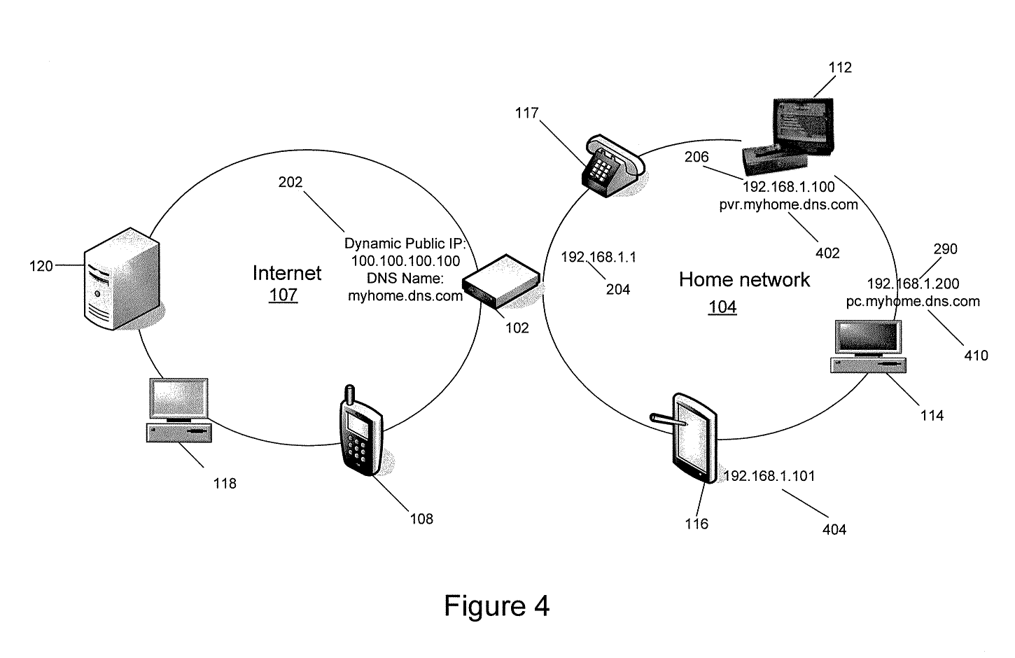

FIG. 4 illustrates a first aspect of the invention in which a home network 104 utilizes a gateway 102 which acts as NAT box. The gateway 102 may provide Internet connectivity to the home devices 112, 114, 116 and 117. Gateway 102 may have a dynamic public IP address provided by the Internet Service Provider such as IP address 100.100.100.100 (202). In addition, the gateway 102 may also have an internal IP address, which for purposes of illustration may be an address such as address 192.168.1.1 (204). Moreover, gateway 102 may implement a DHCP server for assigning private IP addresses to the other home devices in the form 192.168.1.x. For example, PVR device 112 may be assigned an internal IP address of 192.168.1.100 (206) and PC (114) may get assigned an internal IP address of 192.168.1.200 (290).

In an aspect of the invention, gateway 102 may implement a dynamic DNS client. When the public IP address of gateway 102 changes, gateway 102 may notify dynamic DNS provider. The DNS provider may enter the new address in their DNS database. In this example, we suppose that the user has subscribed to an external free dynamic DNS provider, and has mapped the IP address 100.100.100.100 (202) to the name myhome.dns.com (changes of the public IP address are automatically communicated to the DNS provider from the gateway, using existing protocols).

As illustrated in FIG. 4, gateway 102 may act as a NAT, DHCP, and firewall (and possibly a WLAN access point). In addition, in accordance with an aspect of the invention, gateway 102 may also act as a DNS server for internal network 104.

As home devices 112, 114, 116, and 117 receive their IP address from the DHCP protocol, they are informed that DNS queries should be made to the local DNS server (=gateway=192.168.1.1). Gateway 102 (from the dynamic DNS provider), may have a public domain name myhome.dns.com as illustrated in FIG. 4. Therefore, gateway 102 enters (in its internal DNS database) mappings for all internal devices with the format xxx.myhome.dns.com. For example: 192.168.1.100 (206)=pvr.myhome.dns.com (402) and 192.168.1.200 (290)=pc.myhome.dns.com (410).

The mapping may only be done through the internal DNS server. As such only the resolved names are given to internal devices. At the same time, wildcard resolving may be used on the dynamic DNS provider such that the dynamic DNS provider has the original mapping of: myhome.dns.com=100.100.100.100. Through use of wildcards (*) gateway 102 resolves *.myhome.dns.com=100.100.100.100, where * can be anything. For example PVR 112 may include pvr.myhome.dns.com=100.100.100.100 and pc.myhome.dns.com=100.100.100.100 and anything.myhome.dns.com=100.100.100.100. This mapping is provided by the external DNS server (hosted at the dynamic DNS provider). Therefore, these results are returned to any external host trying to resolve names under the myhome.dns.com sub-domain.

As those skilled in the art will realize from the above discussion home addresses are resolved differently from the same domain name, depending if the requester is in the home network or external to the home network. The case that some client tries to connect to xxx.myhome.dns.com from home network 104 is resolved (from the internal DNS) to one of the internal IP address (192.168.1.yyy), and then the client can directly communicate with the device.

In the case of a remote connection such as smart device 108 trying to connect to the same xxx.myhome.dns.com an attempt to resolve the name is made. Smart device 108 may be given, from the dynamic DNS service provider database, the IP address of gateway 102. An HTTP connection to gateway 102 is opened and an HTTP request is made. From the HTTP headers gateway 102 understands that the connection is for the device xxx.myhome.dns.com, so it connects to that device and makes the same request on behalf of smart device 108. Gateway 102 returns the results to the requester, acting as an HTTP proxy.

In another aspect of the invention, gateway 102 may discover the name of a new home device through UPNP or web server probing. Using UPnP device discovery, a newly added home device may advertise itself and its services to the gateway when connected. From those advertisements, the gateway can get the “friendly” name and assume that this name may be used for naming the device. If multiple devices with the same name are in use, the gateway may add numeral at the end of their names, such as Pvr1, pvr2, etc. Then, from the MAC address information one may ensure that exactly the same name is assigned to the same device every time it reconnects.

In the alternative, web server probing may be used to discover the name of a new home device connected to a home network. When a new device is added, the gateway may try to connect on port 80 of that device, where web servers usually run. If a web server is there, it may try to get the title of the main page, and use that title as the name of the device. As a further alternative, manual configuration may be used to discover the name of a connected new home device where a user may open a configuration page of the gateway and manually assign the desired names. This configuration needs to happen only once per device.

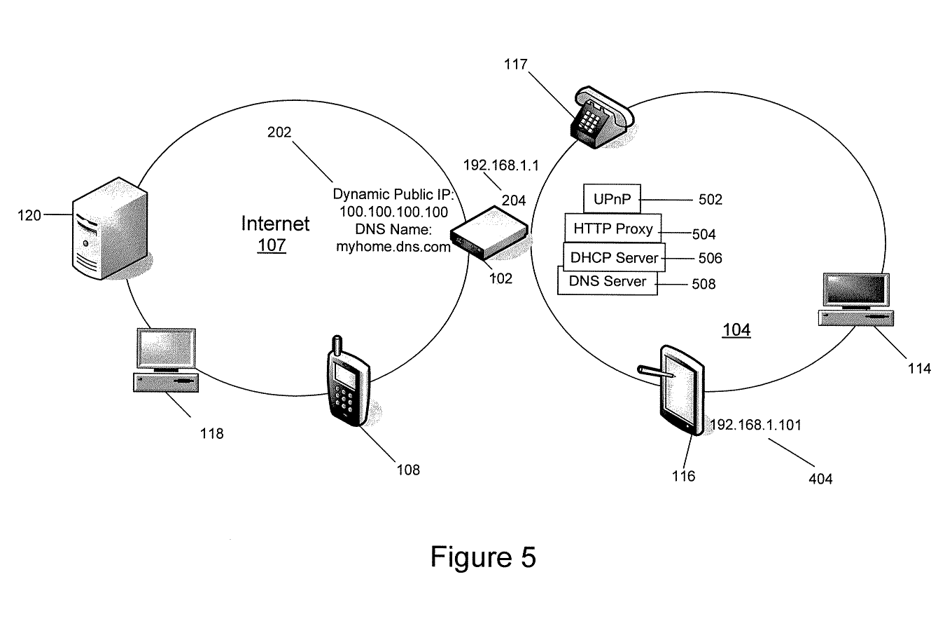

In further aspects of the invention, FIGS. 5-16 illustrate a method of accessing or controlling new devices added to a network from internal or external locations. As illustrated in FIG. 5, a home network 104 may be connected to an external network such as Internet 107 through a gateway 102. The gateway 102 may include various components and functionality such as DNS Server 508, a DHCP Server 506, a HTTP Proxy 504, and UPnP functionality 502. In FIG. 5, a user has registered to a dynamic DNS service and the domain name myhome.dns.com (202) has been mapped to a public IP address of 100.100.100.100.

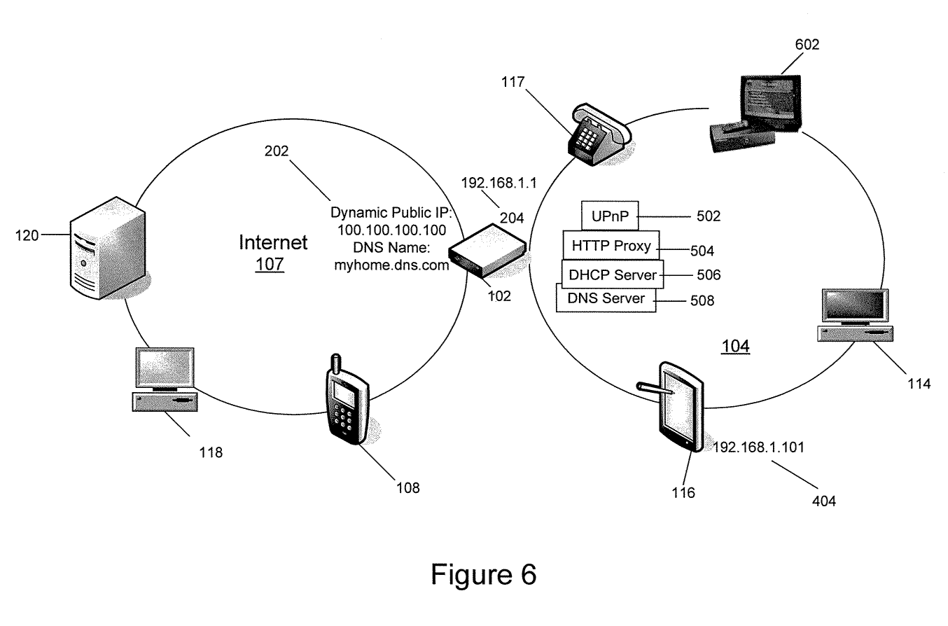

In FIG. 6, a new device such as PVR 602 has been added to home network 104.

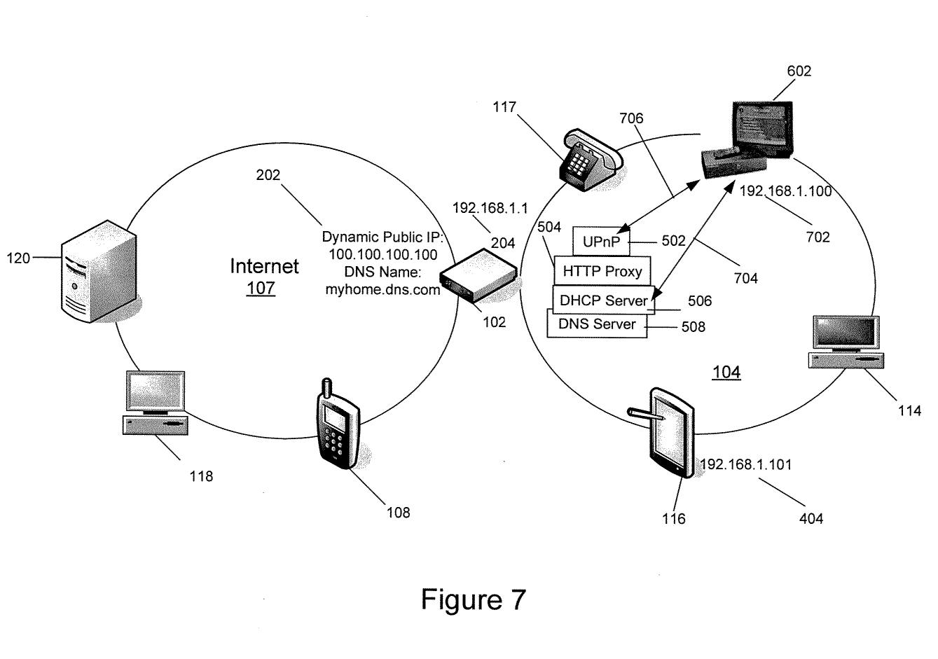

Existing devices already connected to home network 104 may include a home computer 114, a tablet PC 116, and a VoIP phone 117. In FIG. 7, PVR 602 connects to home network 104 (wireless or wired) and communicates with DHCP server 506. The DHCP server 506 may assign a private IP address to PVR 602 (path 704; for example 192.168.1.100 (702)), and at the same time discover that gateway 102 and DNS server 508 are at an IP address of 192.168.1.1 (204).

Once the PVR 602 has IP connectivity, it may announce itself and the services it may provide over UPnP 502 (illustrated as path 706). Gateway 102 receives the announcements and from the UPnP device/service descriptions discovers the friendly name of PVR 602. For example, the friendly name for PVR 602 may be “pvr.”

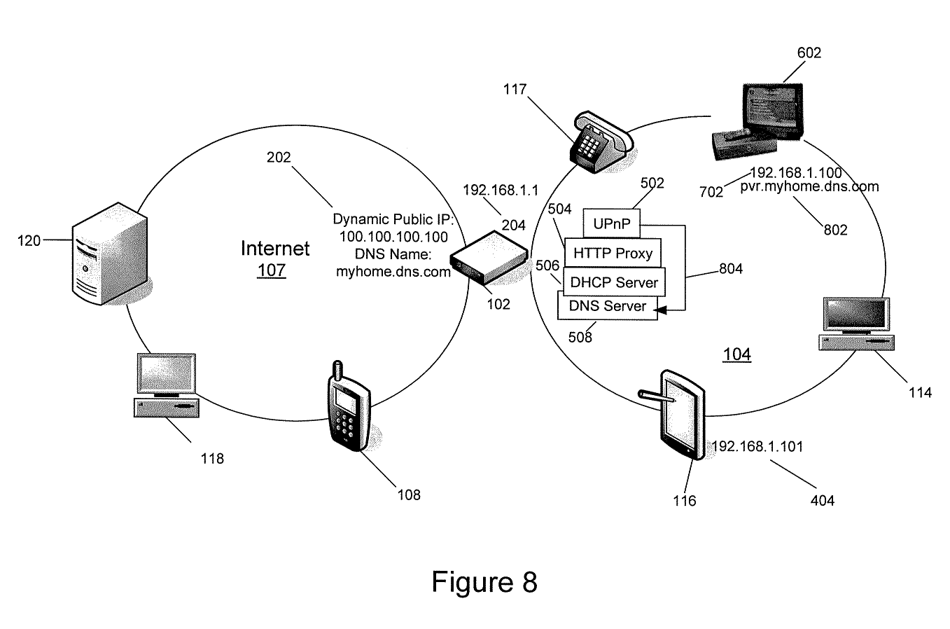

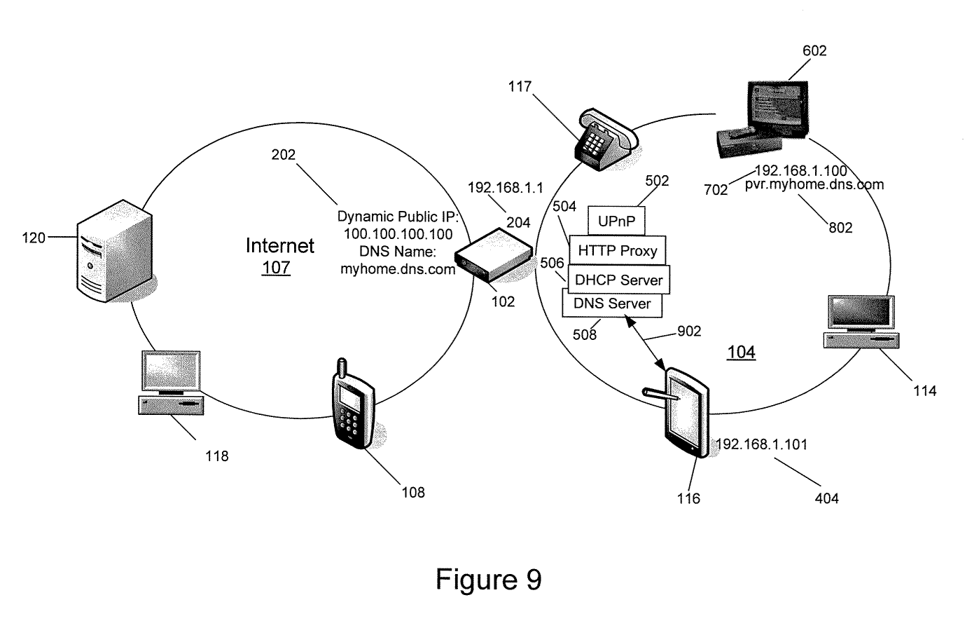

As illustrated in FIG. 8 at path 804, gateway 102 may make an entry in its database that pvr.myhome.dns.com (802)=192.168.1.100 (702). If an internal device such as tablet PC 116 tries to access pvr.myhome.dns.com (802), a DNS query may be made to home DNS server 508 (illustrated as path 902 of FIG. 9). The server 508 may reply that the pvr.myhome.dns.com (802) is located at IP address 192.168.1.100 (702).

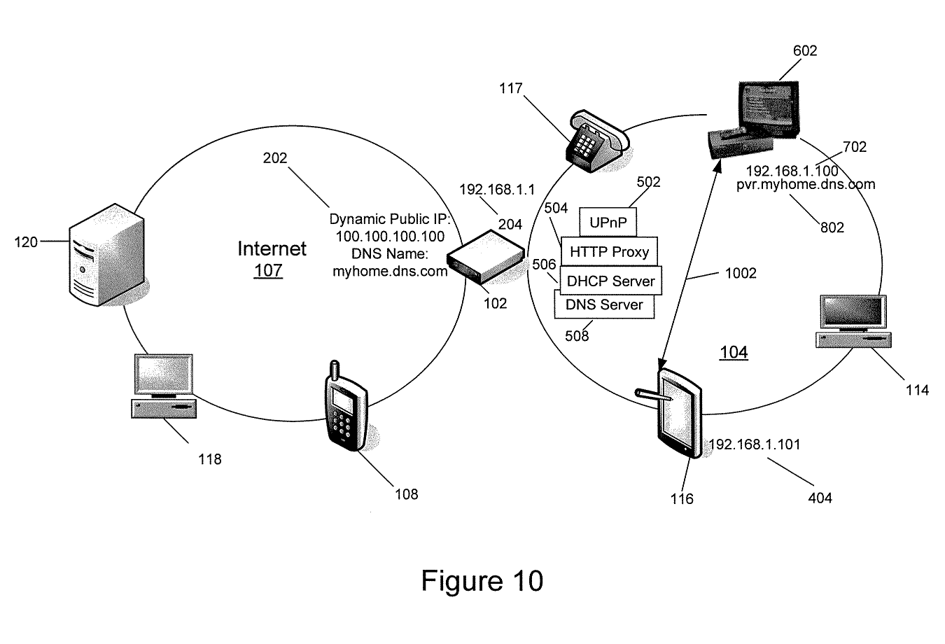

FIG. 10 illustrates that internal devices may directly access services of other devices. For example, tablet PC 116 may directly access PVR 602 through a path 1002. Those skilled in the art will realize that all HTTP related protocols (RSS, Atom, WebDAV, UpnP, etc.) used for accessing devices such PVR 602 use as a destination address: http://pvr.myhome.dns.com. Therefore, a user may make bookmarks and client configurations in their devices that PVR 602 is located at http://pvr.myhome.dns.com.

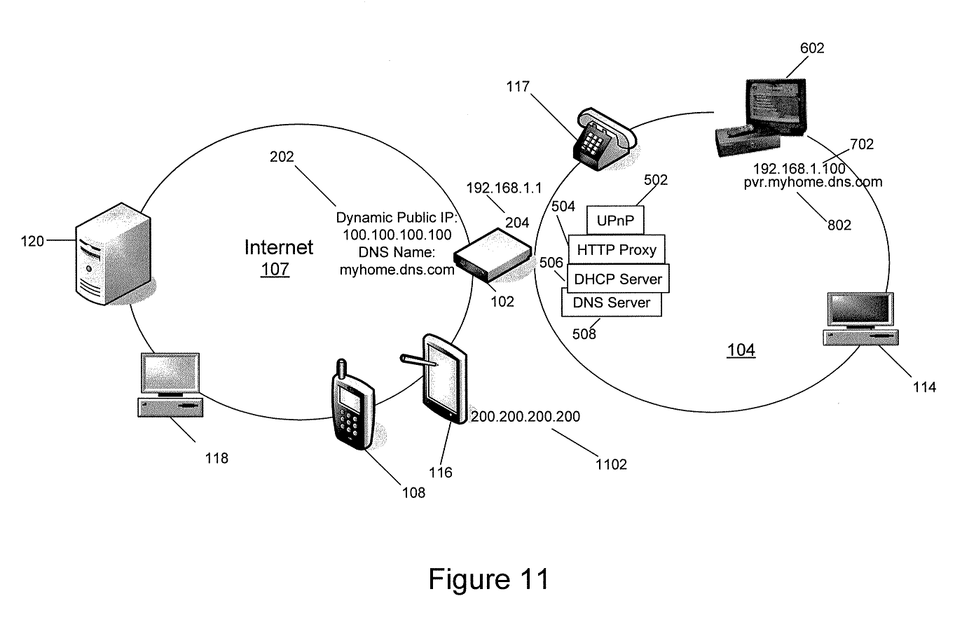

FIG. 11 illustrates that external devices may access or control devices on home network 104 in accordance with an aspect of the invention. In FIG. 11, tablet PC 116 has been moved by its user from home network 104 to an external network such as Internet 106. For example, the user has physically taken tablet PC 116 from the home network 104 and is working remotely in a coffee shop via a public WiFi spot. The tablet PC 116 receives a new IP address such as 200.200.200.200 (1102) due to its new connection to the external network, namely Internet 106. However, as one will quickly realize, tablet PC 116 still has stored in its browser bookmarks and configurations created for PVR 602, created when tablet PC 116 was connected to internal home network 104. That is a bookmark for http://pvr.myhome.dns.com (802) may still be stored in the browser of tablet PC 602. Similar bookmarks/configurations may exist for other home devices and also in other mobile/external devices (e.g. Office PC 114).

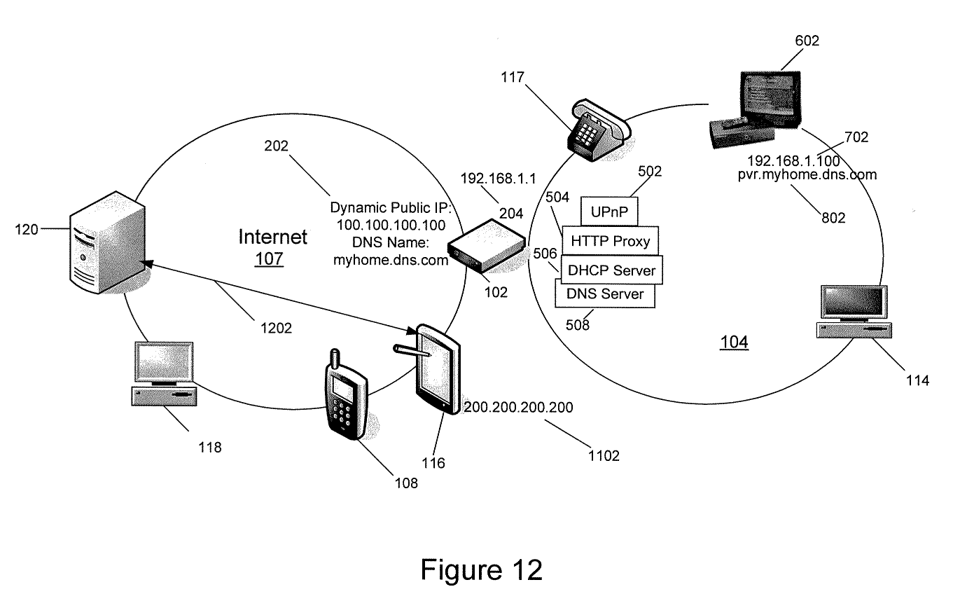

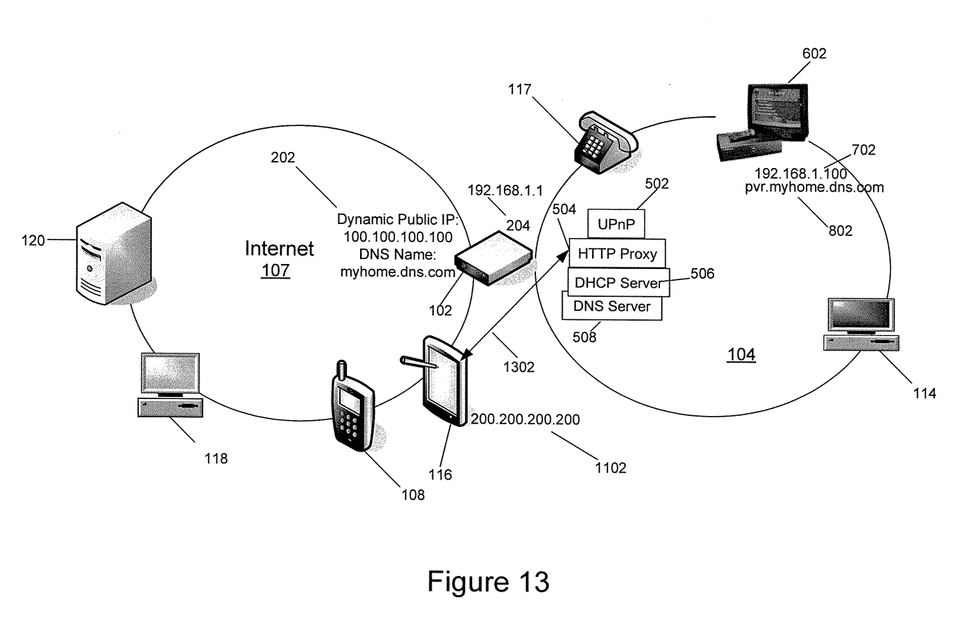

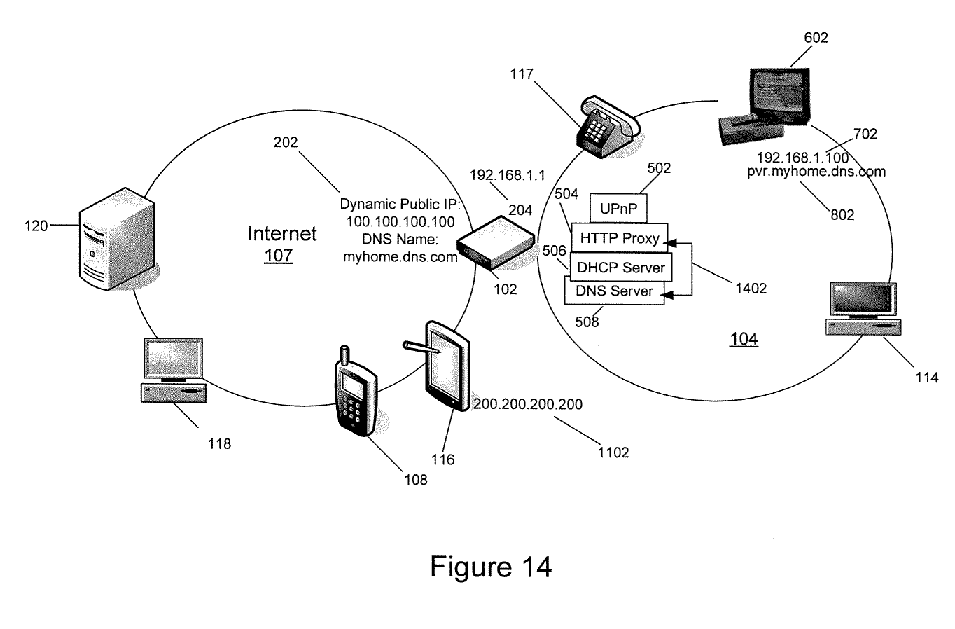

In order to resolve the address conflict, tablet PC 116 in accordance with an aspect of the invention may try to contact a Dynamic (DNS) provider as illustrated by server 120 located on Internet 106. The DNS provider may reply through a path 1202 of FIG. 12 that IP address of gateway 102 is 100.100.100.100. Tablet PC 116 upon receiving the IP address of gateway 102 may establish a HTTP connection (path 1302 of FIG. 13) to gateway 102 HTTP proxy 504 at the IP address of 100.100.100.100 (202). The HTTP specifies the “host” (required as part of HTTP 1.1), which is “pvr.myhome.dns.com.” In gateway 102 the HTTP proxy 504 may consult the internal DNS server 508 to identify the IP address of PVR 602 which is 192.168.1.100 (702) as illustrated in FIG. 14.

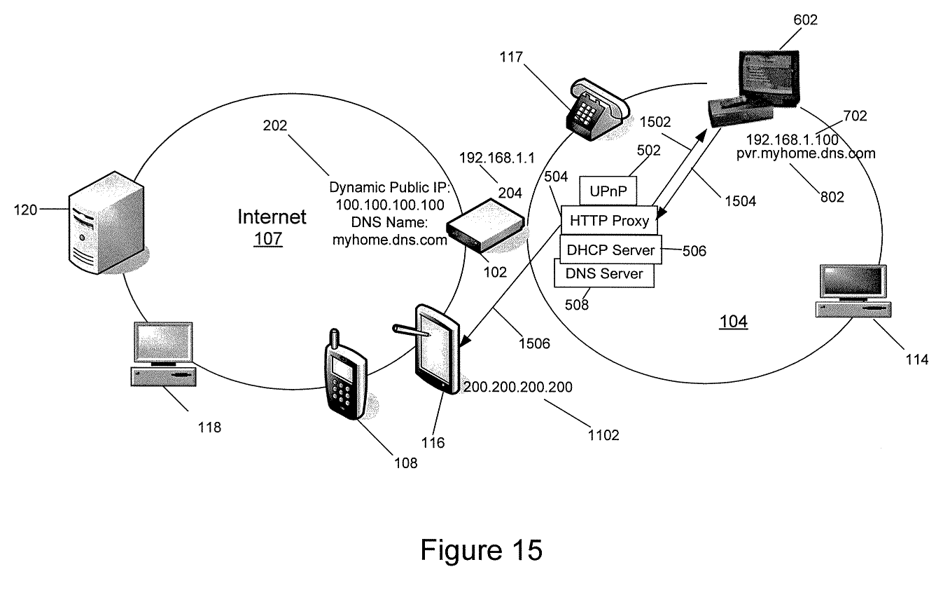

In FIG. 15, the HTTP proxy 504 may open a connection to the PVR 602 through a path 1502. The HTTP proxy 504 forwards the original HTTP request to PVR 602, through a path 1502, and gets a reply from the PVR 602 through a path 1504. The reply may be sent back to Tablet PC 116 through a path 1506. The HTTP communications are accomplished transparently to the user. From tablet PCs 116 point of view, PVR 602 is at URL: http://pvr.myhome.dns.com. Furthermore, PVR 602 is at this address for all devices (internal and external). Therefore, no HTTP level translations and rewrites in the content are needed.

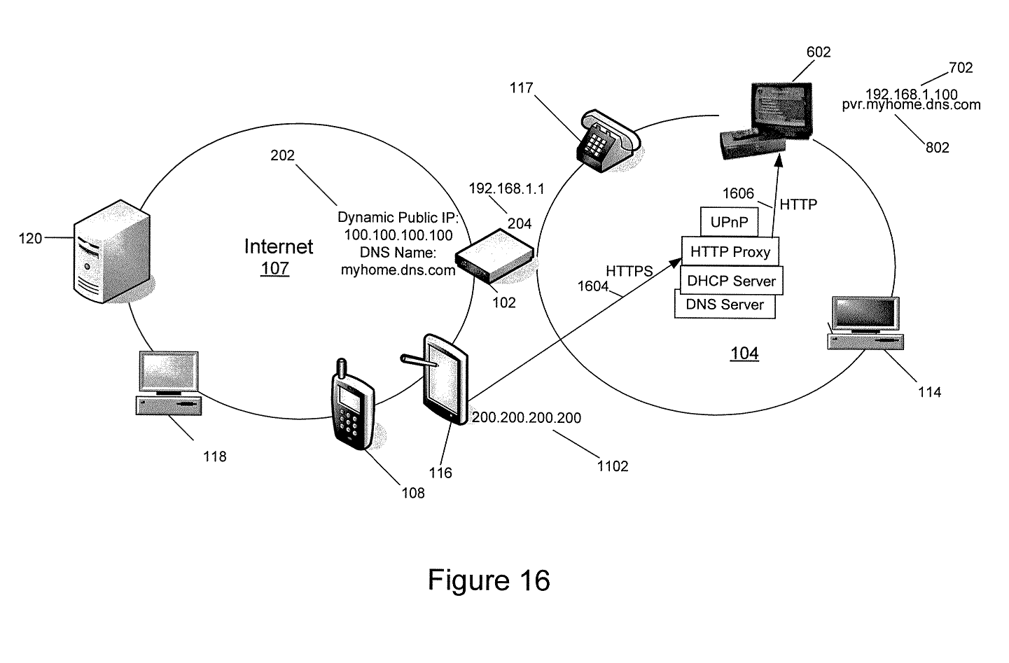

In another aspect of the invention, as shown in FIG. 16, when an external HTTP connection is created to a home gateway, on unsecured port 80, the connection may be automatically redirected on HTTPS port 443 in order to enhance security. Thus, external devices may communicate with HTTPS (path 1604) to the gateway (for security), but the HTTP proxy may still create a normal HTTP connection (path 1606) to the home devices, within the secure and trusted home network 104. Moreover, the suggested solution may be used also for accessing UPnP home devices, from external UPnP control points. Assuming that the initial device discovery is solved with some other way, such as that the remote device was initially in the home network and has cached the existing UPnP devices there. Then a remote device can make UPnP/HTTP requests to the home devices via the proxy.

In other aspects of the invention, gateway 102 may include a DNS server accessible also from the Internet, and act as an authoritative DNS server for the sub-domain .myhome.dns.com. With this approach when an external host is trying to resolve the address (for example) pvr.myhome.dns.com, will not get a direct reply from the dynamic DNS service provider (so no wildcards used in this case). Instead, it will be instructed to contact the DNS server running on the gateway, for resolving the specified name.

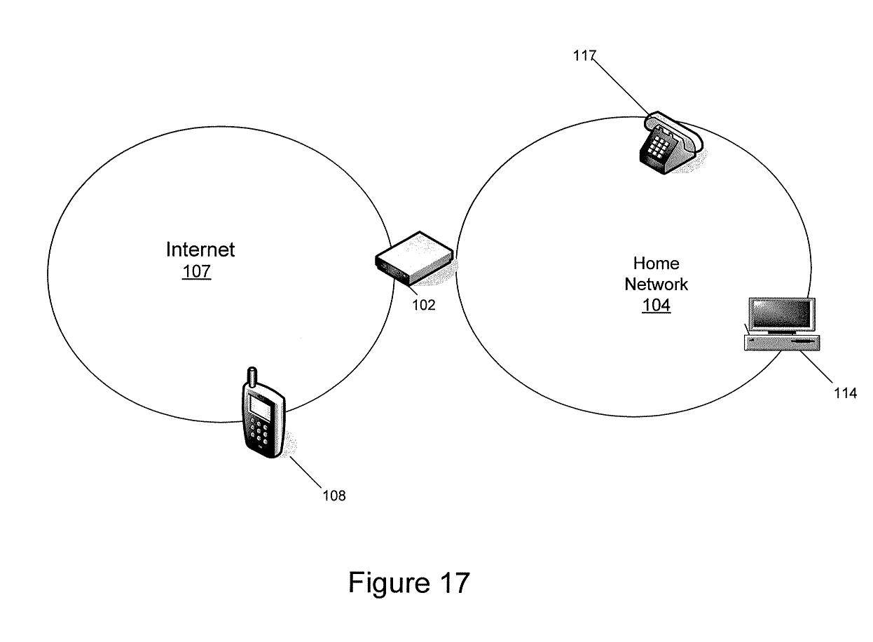

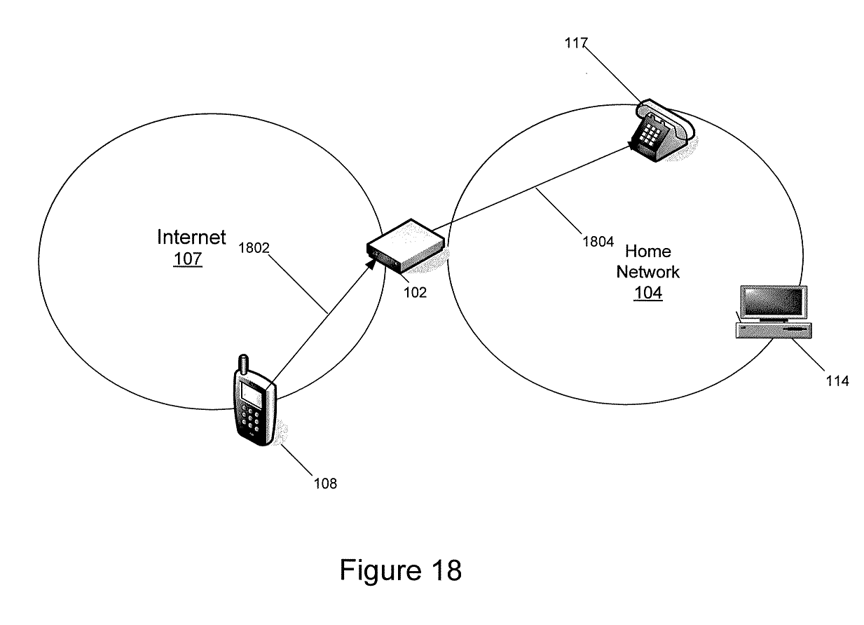

FIGS. 17-22 detail another aspect of the invention in which a dynamic DNS mechanism is used as a rendezvous mechanism for signaling real time applications. In FIG. 17, a home network 104 is connected to an external network such as Internet 106 through a gateway 102. Home network 104 may include devices such as a VoIP phone 117 and personal computer 114. As described above with respect to FIGS. 5-16, VoIP phone 117 may be reached from an external network but only for HTTP communication. Therefore, VoIP phone 117 will not be able to be accessed or controlled as VoIP requires its own UDP/TCP port to work. In an aspect of the invention and as illustrated in FIGS. 18-20, a HTTP/DynamicDNS solution may be used for signaling and a port opened through a firewall to allow for the actual VoIP data.

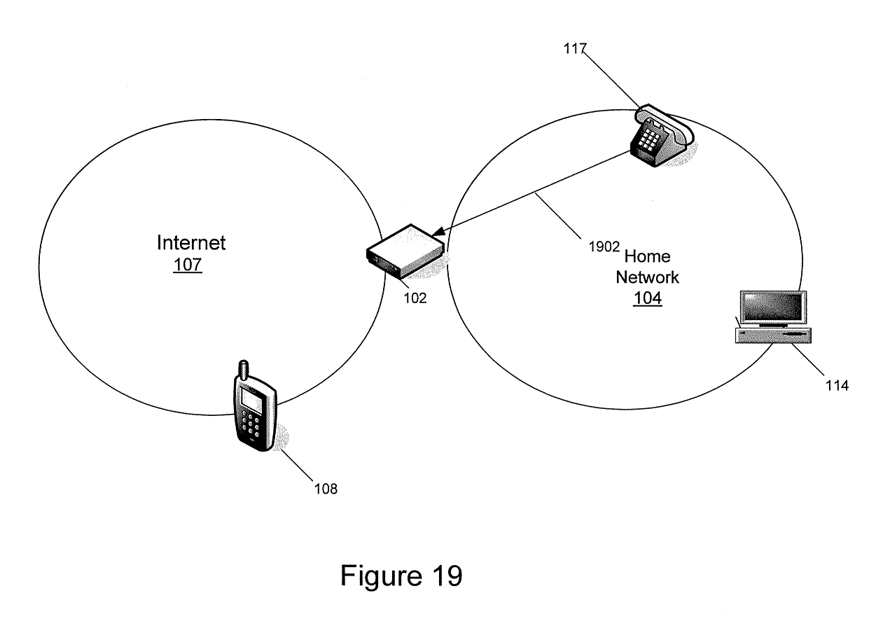

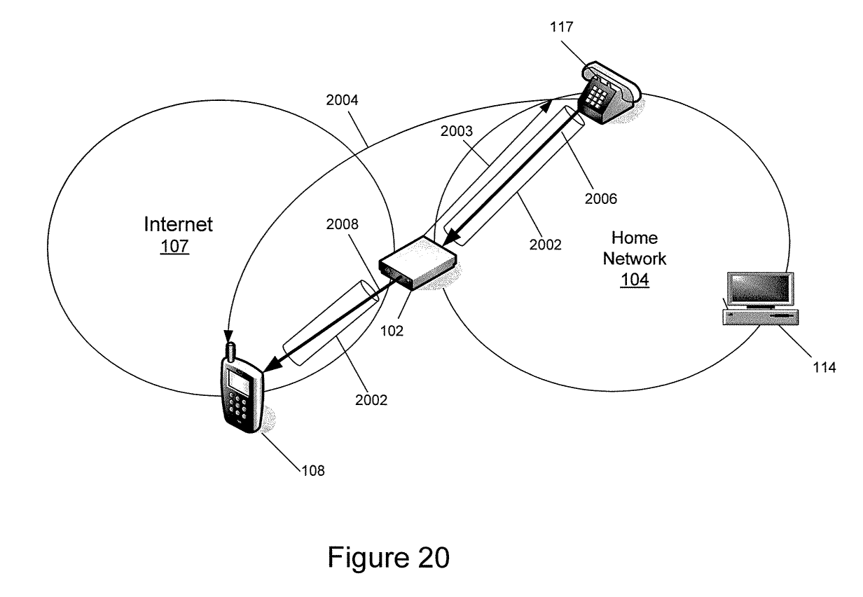

In particular FIG. 18 illustrates a smart device 108 initiating a HTTP request through gateway 102 to VoIP phone 117 (paths 1802 and 1804). In the request, the smart device 108 requests VoIP communication from the VoIP phone 117 in the form of TCP/UDP ports through which the devices may communicate using VoIP protocols. In response, VoIP phone 117 requests from gateway 102 that TCP/UDP ports be redirected from the Internet public IP address to the VoIP phone's 117 internal address (path 1902 of FIG. 19). The request may be made using UPNP. In response to the request, gateway 102 allocates ports such as port 2002 (FIG. 20) enabling port forwarding rules and communicates to the VoIP phone 117 information 2203 concerning ports that have been allocated.

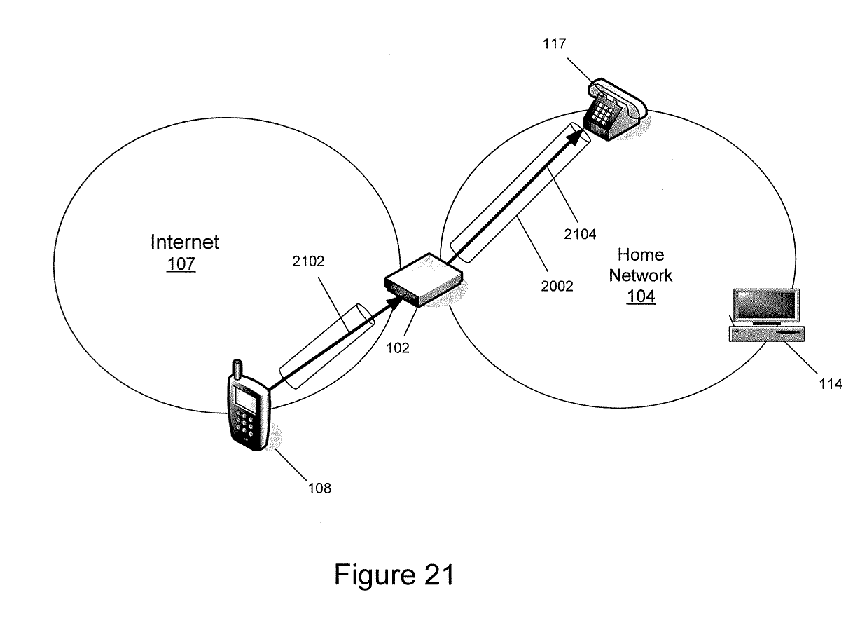

In addition, VoIP phone 117 may reply to the original HTTP response by smart device 108 with information regarding what ports have been allocated for the communication (path 2204). Moreover, smart device 108 may make direct TCP/UDP data transfers through the given port 2002 (FIG. 21). When the connection is terminated, VoIP phone 117 may inform gateway 102 to close the opened ports and stop the forwarding. Therefore, in this aspect of the invention the data need not be HTTP data.

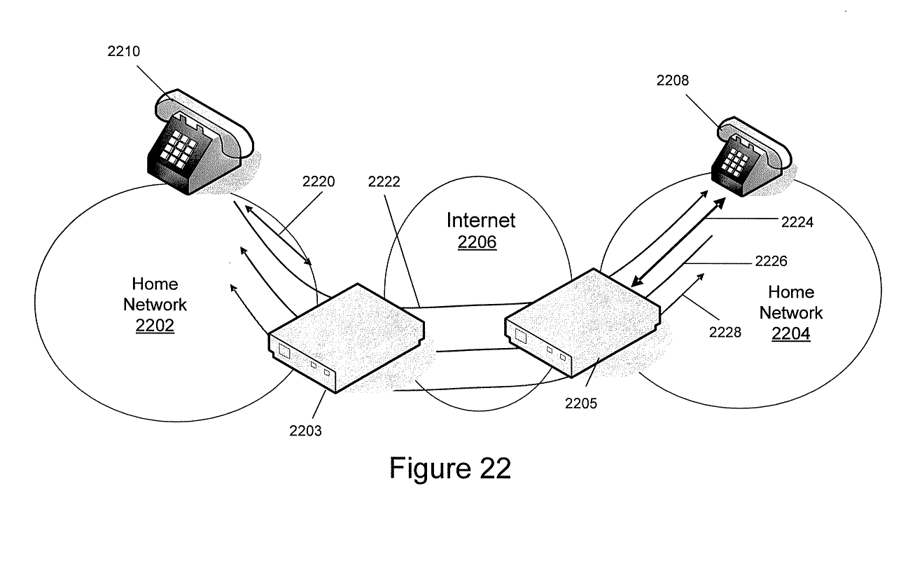

FIG. 22 illustrates another aspect of the invention in which the dynamicDNS mechanism may work when both devices are behind firewalls. For example, in FIG. 22 a first VoIP phone 2210 and a second VoIP phone 2208 are protected by firewalls established through gateways 2203 and 2205. The first VoIP phone 2210 may be part of a first home network 2202, whereas, the second VoIP phone 2208 may be part of a second home network 2204. In order to communicate, the first VoIP device 2210 may open some ports on its associated firewall in a step 2220. Next in a step 2222, the first VoIP phone 2210 would contact the second VoIP phone 2208 through a HTTP connection and provide the second VoIP phone 2208 with information regarding open ports and the first home networks 2202 public IP address.

Next, is step 2226 second VoIP phone 2208 may in response to the received message from first VoIP phone 2210 open ports for use in receiving non-HTTP information. In step 2226, second VoIP 2208 forwards its opened port information to first VoIP phone 2210 in the form of a HTTP response. As both VoIP devices (2210 and 2208) have revealed their open port to each other, VoIP communication may begin.

Furthermore, while the present invention has been described with respect to specific examples, those skilled in the art will appreciate that there are numerous variations and permutations of the above described method and system that fall within the spirit and scope of the invention as set forth in the appended claims.

We claim:

1. A method for accessing network devices through a gateway, the method comprising:
a) receiving a request from a local device located on a local network for an internal IP address associated with the local device;
b) determining the internal IP address and a host name for the local device;
c) transmitting the internal IP address and the host name to the local device;
d) receiving a request for access to the local device from a remote device on an external network;
e) transmitting a public IP address of the gateway to the remote device;
f) receiving a HTTP request, the HTTP request including a header field with a domain name of the local device; and
g) transmitting data between the remote device and the local device.

2. The method of claim 1 further comprising:
h) receiving a request for access to the local device from a second local device on the local network; and
in response to h) transmitting the internal address of the device to the second local device.

3. The method of claim 1, wherein the gateway further comprising DNS server functionality.

4. The method of claim 1, wherein the gateway further comprising DHCP server functionality.

5. The method of claim 1, wherein the gateway further comprises HTTP proxy functionality.

6. The method of claim 1, wherein the gateway comprises UPNP functionality.

7. The method of claim 1, wherein the HTTP header field includes

8. The method of claim 1, wherein the local device comprises a smart device.

9. The method of claim 1, wherein the local network comprises a home network.

10. The method of claim 1, wherein the external network comprises the Internet.

11. A method for accessing network devices through a gateway, the method comprising:
a) receiving a HTTP request, the HTTP request including access to TCP/UDP ports;
b) transmitting the request to a local device located on a local network;
c) receiving a request from the local device that TCP/UDP ports be redirected from a public Internet IP address to the local deice internal IP address;
d) allocating the TCP/UDP ports;
e) terminating the allocated TCP/UDP port upon a request for termination from the local device.

12. The method of claim 11, wherein step d) further comprises opening the TCP/UDP ports.

13. The method of claim 11, wherein the gateway further comprising DHCP server functionality.

14. The method of claim 11, wherein the gateway further comprises HTTP proxy functionality.

15. The method of claim 11, wherein the gateway further comprising DNS server functionality.

16. The method of claim 11, wherein the gateway comprises UPnP functionality.

17. A gateway device for address translation between an external network and a local network, the gateway device comprising:
a communication interface;
a storage medium; and
a processor coupled to the storage medium and programmed with computer-executable instructions to perform the steps comprising:
receiving a request from a local device located on the local network for an internal IP address associated with the local device;
determining the internal IP address and a host name for the local device;
transmitting the internal IP address and the host name to the local device;
receiving a request for access to the local device from a remote device on the external network;
transmitting a public IP address of the gateway to the remote device;
receiving a HTTP request, the HTTP request including a header field with a domain name of the local device; and
transmitting data between the remote device and the local device.

18. The device of claim 17, wherein the gateway device further comprising DNS server functionality.

19. The device of claim 17, wherein the gateway device further comprising DHCP server functionality.

20. The device of claim 17, wherein the gateway device further comprises HTTP proxy functionality.
